(19) United States
(12) Patent Application Publication
(10) Pub. No.: US 2026/0161790 A1
(43) Pub. Date: Jun. 11, 2026

(54) AN AUTOMATED API-BASED PORT AND VULNERABILITY

(71) Applicant: ISTANBUL MEDIPOL UNIVERSITESI TEKNOLOJI TRANSFER OFISI ANONIM SIRKETI, Beykoz, Istanbul (TR)

(72) Inventors: Reda ALHAJJ, Beykoz, Istanbul (TR); Malek MALKAWI, Beykoz, Istanbul (TR)

(21) Appl. No.: 18/708,001

(22) PCT Filed: Oct. 17, 2022
(86) PCT No.: PCT/TR2022/051143

§ 371 Date: May 7, 2024

(30) Foreign Application Priority Data
Nov. 9, 2021 (TR) 2021/017485
May 20, 2022 (TR) 2022/008172

(51) Int. Cl. G06F 21/57

(52) U.S. Cl. CPC G06F 21/577; G06F 2221/034

(57) ABSTRACT

Disclosed is an automation method for the active information-gathering phase that can be used during penetration testing and by system administrators. The method is an automated API-based IP and port scanner, service-version enumerator, and vulnerability detection system.

### TECHNICAL FIELD

This invention relates to an automation method for the active information-gathering phase that can be used during penetration testing and by system administrators. The method is an automated API-based IP and port scanner, service-version enumerator, and vulnerability detection system.

### PRIOR ART

The unprecedented growth in technology has increased the importance of the required information security that is still hard to be reached. Recently, network and web application attacks have occurred frequently, causing confidential data to be stolen by the available vulnerabilities in the systems and the most prominent is in the form of open ports. This causes the CIA (Confidentiality Integrity and Availability) Triad Model to break. The huge gap in the automation of penetration testing process and the lack of the available methods are the main technical problems that lead the inventor to pursue research in this field. Without such a method, it is really hard to accurately detect the possible threats and potential attacks against the system in short time.

Research towards automatic and comprehensive tools is still in its infancy and is almost nonexistent. Most of the previous works have been trying to discover and find the vulnerability by manual approaches. Besides its manual methodologies, they are only considering a specific kind of attacks. While a few studies focused only on determining the operating system of the target system, others, are trying to detect only specific vulnerability.

The current solutions present in the art depend on a variety of tools. For example, to be able to check a small or large scale network, a lot of tools should be used separately and independently to go over the used technologies and the devices. While a few studies focused only on gathering information regarding specific operating system or technology of the target system, others, are trying to detect only specific kind of vulnerability. One of the previous studies developed a command line application that locates and stores an organization's footprint and looks for sensitive information, such as data repositories, to enhance an organization's vulnerability assessment process. However, this kind of methods consume a long time to give a result. In another study a system that analyzes coarsely detailed security-related network data of a basic sort and visualizes security-related events of interest has been described.

The methods proposed in the prior art are disadvantageous because these methods are using a lot of tools independently, this not only consumes a huge amount of time, but also, it becomes the reason behind losing valuable information that might be critical in terms of defining the possible security issues and the vulnerabilities in the systems.

In manual approaches, the process takes weeks to check all the devices and used technologies. According to one of the previous published works, performing a manual approach would take one minute per vulnerability. For example, our system was able to detect 42109 vulnerabilities only in five minutes for one of the test cases. According to these studies, the manual approach will take 42109 minutes to make the critical work that can be done in only five minutes in automated approach (our method). Attempting to enumerate the service-version and vulnerability information from all ports without making any optimization rule to enhance the performance of the operation is the most common mistake made by other researchers.

### AIM OF THE INVENTION

The purpose is to protect the CIA (Confidentiality, Integrity, and Availability) Triad, which is the core of information security with the wave of technological advancement. We aim to provide a generic and optimized approach for automating the process of active reconnaissance phase and penetration testing. Our technique is primarily focused on automating the port scanning and vulnerability assessment phases of reconnaissance, which are handled by Nmap's algorithms, Nmap Scripting Engines (NSEs), and “Vulscan” and “Vulners” modules. We offer a useful schema that will make penetration testers' and system administrators' life easier. Allowing them to scan and secure their networks more quickly.

### BRIEF DESCRIPTION OF THE INVENTION

The method of the invention is an automated API-based IP and port scanner, service-version enumerator, and vulnerability detection system.

This scheme is based on the Network Mapper (Nmap) algorithm to collect the information with high accuracy depending on the provided rules in our schema. Besides, the work has been implemented as a RESTful-API server, aiming at easy integration for real-life cases and allowing administrators to scan and secure their networks more quickly and easily. The effectiveness and efficiency of this technique has been proved by the various test cases applied considering different scenarios from the real world. The average time of scanning a server and detecting the vulnerabilities is 2.2 minutes. Regardless of the number of vulnerabilities, the increase in time for each open port is just about 12 seconds.

Compared to the prior art methods our suggested method will play an important role in system security by allowing companies and system administrators to scan their systems on a frequent and regular basis with the minimal resources they have. Furthermore, this allows for rapid updates to newly discovered software vulnerabilities. Our scanner is used to demonstrate how simple it is to scan a complicated enterprise-grade web application. At the same time, it has been implemented as API server which means it can be integration with any kind of systems irrespective of the used technologies or hardware. It can be entirely scalable and flexible to any system according to their demands and growth.

The method according to the invention can be used to scan any network or system in automated way to check frequently and regularly for any possible security issue, vulnerability or threat in the system. It can be used to warn the administrators about newly discovered software vulnerabilities. It has been developed as API to provide easy integration. In general it is an automation of Active Reconnaissance Phase. That's why, it can be used as an automated API-based port and vulnerability scanner.

Mainly it is expected to close the huge gap by automating the network scanning and vulnerability assessment processes for small and large networks and the lack of the available methods. It will play a big role in protecting network and web application against the possible attacks. It will prevent the leak of confidential data. By using one automated tool, It will solve the loss of the critical information we can gather from the connections among used technologies. And it will allow tester/administrators to scan systems against the attacks in short time. As it is an API server, It will be a solution that can easily be integrated with the current systems to solve the difficulties faced while switching from one tool to another to complete the process of scanning. At the same time, it gives the opportunity for administrators and researchers to prove that a host is vulnerable to certain attacks or not by automated periodic scans.

The method has been proved by the various test cases applied considering different scenarios from the real world. The results of the test cases were satisfying and beyond our expectations. The outcomes were very successful in comparison to a more manual technique. We were able to gather port and vulnerability information in a very short time with high accuracy. The average time of scanning a server and detecting the vulnerabilities is 2.2 minutes. Regardless of the number of vulnerabilities, the increase in time for each open port is just about 12 seconds (manual process takes weeks and almost 1 minute per vulnerability). Most of the advantages has been explained in the previous parts. One of the unique elements of it is being one the first comprehensive automated toots in this limited area and the high performance of it.

### LIST AND EXPLANATION OF FIGURES

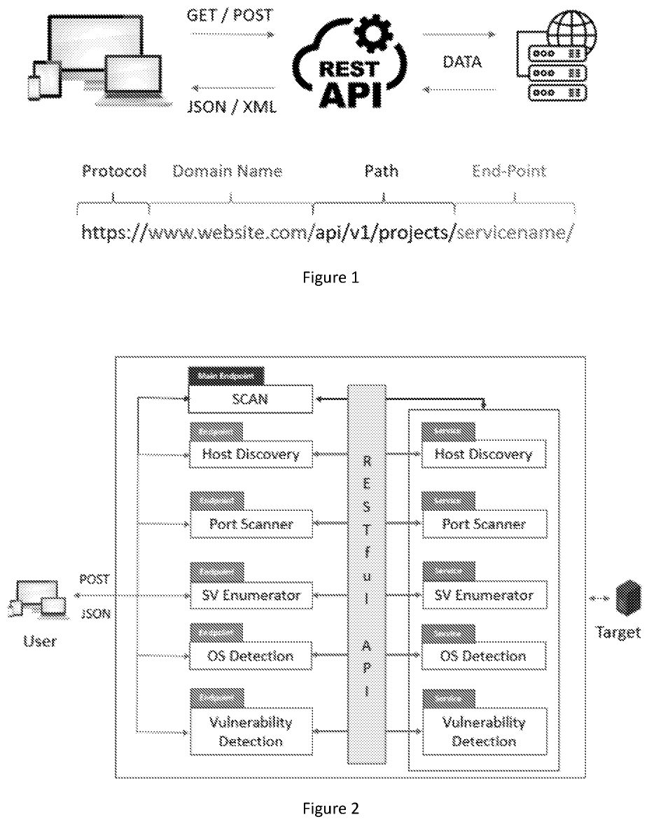

FIG. 1: Schematic representation of RESTful API (REpresentational State Transfer Application Programming Interface) architecture
101: Get/Post
102: JSON/XML
103: Data
104: Protocol
105: Domain Name
106: Path
107: End-point 108: Rest API

FIG. 2: Schematic representation of the general structure of the method according to present invention
201: User
202: Post
203: JSON
A: Main endpoint
204: Scan
B: Endpoint
205: Host Discovery
206: Port Scanner
207: Service and Version Enumerator
208: Operating System detection
209: Vulnerability detection
C: Service
210: Target

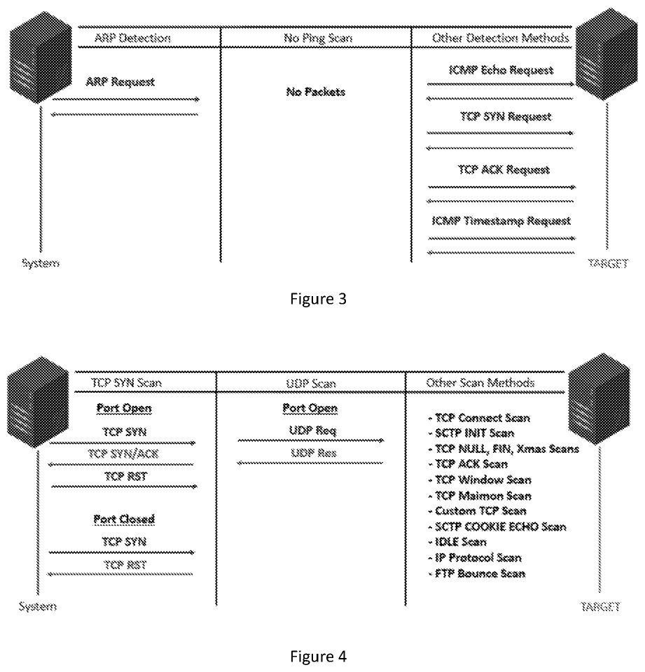

FIG. 3: Schematic representation of host discovery methods
301: ARP detection
302: No Ping Scan
303: Other Detection Methods
304: System
305: ARP Request
306: No packets
307: ICMP Echo Request
308: TCP SYN Request
309: TCP SCK Request
310: ICMP timestamp request
210: Target

FIG. 4: Schematic representation of port scan methods
304: System
210: Target
401: TCP SYN Scan
402: UDP Scan
403: Other Scan Methods
404: Port Open
405: Port Closed
406: TCP SYN
407: TCP SYN SCK
408: TCP RST
409: UDP Req
410: UDP Res
411: TCP Connect Scan, SCTP INIT Scan, TCP NULL, PIN, Xmas Scans, TCP ACK Scan, TCP Window Scan, TCP Maimon Scan, Custom TCP Scan, SCTP COOKIE ECHO Scan, IDLE Scan, IP Protocol Scan, FTP Bounce Scan

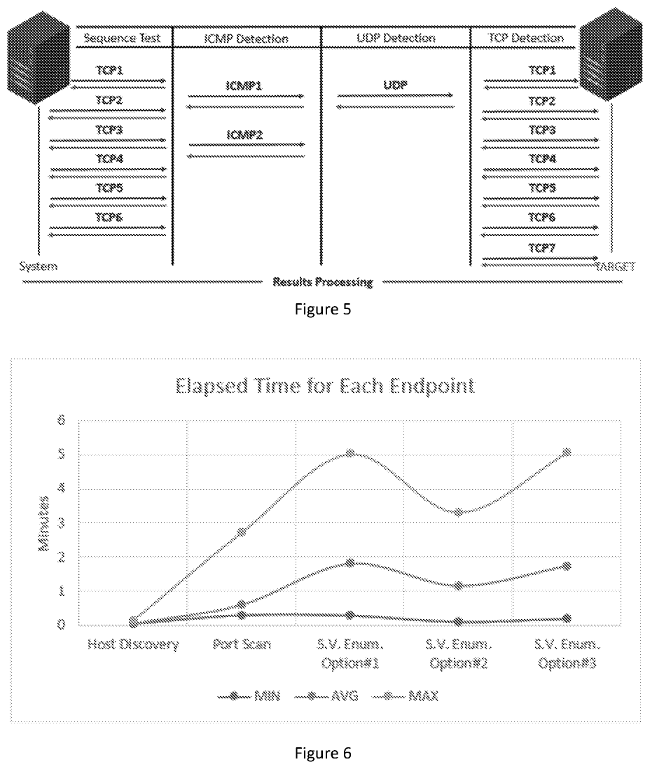

FIG. 5: Schematic representation of OS Detection
501: Sequence Test
502: ICMP Detection
503: UDP Detection
504: TCP Detection
505: TCP1
506: TCP2
507: TCP3
508: TCP4
509: TCP5
510: TCP6
511: TCP7
512: ICMP1
513: ICMP2
514: UDP
515: Results Processing

FIG. 6: Graph showing the time elapsed for each process (endpoint) and the total time
601: Minutes
205: Host Discovery
206: Port Scanner
602: Service and Version Enumerator option 1
603: Service and Version Enumerator option 2
604: Service and Version Enumerator option 3
605: Minimum
606: Average
607: Maximum

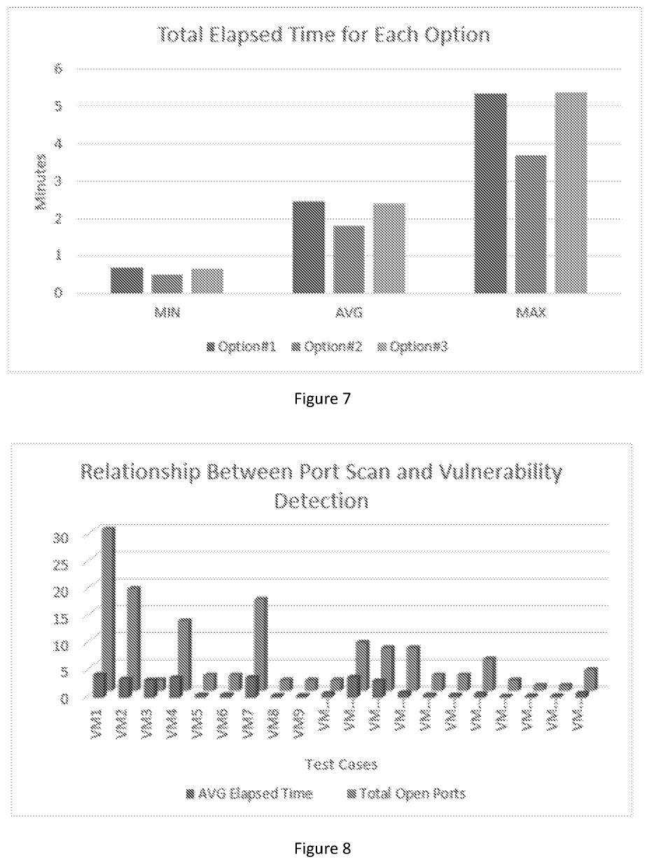

FIG. 7: Graph showing total time elapsed for each option
601: Minutes
602: Service and Version Enumerator option 1
603: Service and Version Enumerator option 2
604: Service and Version Enumerator option 3
605: Minimum
606: Average
607: Maximum

### DETAILED DESCRIPTION OF THE INVENTION

In this invention, we provide an API-based automated network scanner including open port scanner and service-version enumerator and vulnerability assessment application using the Network Mapper (Nmap) Scripting Engine (NSE) integrated with VulScan and Nmap-vulners modules databases to find Common Vulnerabilities and Exposures (CVE). Vulners is an NSE script that makes use of publicly available services to provide relevant information about security vulnerabilities.

In this work, we have proposed a solution that can easily be integrated with the current systems to solve the difficulties faced while switching from one tool to another to complete the process of scanning as the first feature of an automated security engine. The primary goal is to close the gap by automating the network scanning and vulnerability assessment processes for small and large networks. At the same time, it gives the opportunity for administrators and researchers to prove that a host is vulnerable to certain attacks or not by automated periodic scans.

The essential components used to implement the invention will now be explained, along with the methodological approach in terms of the general structure.

Python Programming Language (also known as Python) is a high-level programming language with a design philosophy that prioritizes readability. Its features and object-oriented approach are designed to help programmers write clean code for both small and large-scale projects. Besides, it's a beneficial language for cybersecurity since it is capable of doing a wide variety of cybersecurity tasks, such as malware analysis, scanning, and penetration testing. Those are some of the reasons why we have decided to write our project with it.

Nmap (Network Mapper) is an open-source network scanning and discovery tool widely used for scanning the state of a target host, and it provides comprehensive scan types and firewall evasion methods. Each technique can be customized and made to be as noticeable or as inconspicuous as possible. It can be used to find open ports, communication protocols (TCP/UDP), services and versions used on each port, as well as vulnerabilities on a remote device. The data acquired can be used to improve the system in terms of preventing future attacks. Our schema relies on Nmap algorithms to gather the required information regarding the target.

One of Nmap's most vital and flexible features is the Nmap Scripting Engine (NSE). It allows users to build simple scripts to automate a wide range of networking functions using a programming language called Lua. Those scripts are run in parallel, with the speed and efficiency that Nmap is customized for. Users can use the built-in scripts of Nmap's library or develop their own to fulfill their specific needs. NSE's key tasks include network discovery, more sophisticated version detection, vulnerability detection, and backdoor detection. It can even be used for vulnerability exploitation.

Flask is a Python-based micro-framework as it does not necessitate the usage of any specific tools or libraries. It doesn't have a database abstraction layer, form validation, or any other components that rely on third-party libraries to do typical tasks. When it comes to designing web applications, Flask gives developers a lot of options. It includes tools, libraries, and mechanisms that allow you to build a web application, but it doesn't impose any dependencies or tell the user how the project should look.

REpresentational State Transfer is a software architectural style that was developed to help in the design and development of the WWW's architecture. REST establishes a set of guidelines for how an Internet-scale distributed hypermedia system, such as the Web, should be designed. As shown in FIG. 1, REST APIs offer a lot of flexibility, which is one of its biggest benefits. REST can accommodate many sorts of calls, return diverse data formats, and even change fundamentally with the correct implementation of hypermedia because data is not linked to resources or functions. Data and functionality are considered resources in the REST architectural style, and they are accessible via Uniform Resource Identifiers (URIs). The most often used protocol is HTTP. Using such an architecture, making projects more appropriate for scaling up and integrate it with other systems. All of these characteristics contribute to the simplicity, lightness, and speed of RESTful applications.

In a preferred embodiment, the method of the invention has been implemented in the Python 3.9 programming language and the Flask Micro Web-Framework as a RESTful-API Server based on Network Mapper (Nmap) algorithms. This approach gives the chance to integrate the project with any system. One main endpoint requiring only an IP input to go over the whole process in an automated approach (a) has been provided, starting with the host discovery (b), port scanning (c), service-version enumeration (d), and ending with vulnerability detection (f). The detailed result of the scan will be preferably presented as JSON, XML or TXT output. Each function of the active reconnaissance process has been implemented as a separate endpoint as shown in FIG. 2 to increase the accuracy and optimize the scheme. Additionally, it allows advanced users to enter their own customized parameters that might be needed. Each function has been explained in the following subsections.

### B: Host Discovery

Host discovery is the first endpoint in our system. “<server-ip>/api/v1/host-check”. At this point, the given IP's (target system) status will be checked if it is active or not and the result will be as “Up” or “Down”. Accordingly, the system will process to the next step (port scan endpoint) automatically. If the result is down then it will go directly to the final step without wasting time with the other scanning methods.

There are three primary host discovery detection methods as demonstrated in FIG. 3. The first one is ARP detection, which in turn broadcasts ARP query packets throughout the LAN. Using a list scan rather than a PING scan by setting the target host's state to “HOST UP” is the second one. The other detection methods include sending four different types of data packets to determine whether the target host is online; An ICMP timestamp request, an ICMP echo request, a TCP SYN packet to port 443, a TCP ACK packet to port 80, and a TCP SYN packet to port 443.

### C. Port Scanning

Port scanning “<server-ip>/api/v1/port-scan” is the schema's second endpoint. By default, the system will start scanning the most known 1000 TCP port, unless the user changes the POST request to scan a specific port range with the demanded network protocol, such as TCP, UDP, or both together. Open ports and the related protocol results will be stored temporarily on the server to be prepared and sent to the next endpoint, which is the service and version enumeration step. In the case of having no open ports detected, the system will terminate the process and show the results.

The goal of a port scan is to determine the target port's operational condition by returning the packet's characteristics. Different probe packets are created for different scan types. Nmap first runs a PING probe operation and transmits the necessary probe packets to the target machine's specified port, as shown in FIG. 4. Then it either waits for the probe packet to be re-transmitted or sends a fresh probe packet. Finally, it is dependent on several detection mechanisms and waits for various types of response packets.

### D. Service and Version Enumeration

At this endpoint “<server-ip>/api/v1/sv-scan”, the system enumerates only the banners of the services on the open ports, then the version of each one. This part is the most vital one, as in the next step we are going to detect the related vulnerabilities. Open ports and the related protocol results will be stored temporarily on the server to be prepared and sent to the next endpoint, which is the service and version enumeration step. In the case of having no open port detected, the system will terminate the process and show the results.

The premise behind this form of scanning is to match the scan findings to the database's service fingerprint or service signature. Thousands of common service fingerprints or sig-nature traits are integrated into the Nmap database. The target system will generate and return the necessary information, which can match the port's service and service version, in response to a request for a specific target port.

### E. OS Detection

To increase the accuracy of the results, we have combined the operating system detection with the previous SV Enumeration endpoint. To identify the operating system, the system uses TCP/IP protocol stack fingerprints. Because there are no mandatory specifications for TCP/IP implementation in some areas in the RFC specification, distinct TCP/IP schemes may have their own unique processing mechanisms. The differences in these characteristics are what Nmap uses to determine the type of operating system. Initially, Nmap runs a sequence generation test, sending six TCP probing packets, and extracting the data fingerprint SEQ/OPS/WIN/T1. It then selects a closed UDP port, a closed TCP port, and an open TCP port for complete TCP/UDP/ICMP detection and fingerprint data extraction, respectively. Finally, it compares the fingerprint attributes of known systems included with Nmap to the findings of the detection.

### F. Vulnerability Detection

Detecting common vulnerabilities and exposures (CVE) and the possible threats are done at this endpoint via the Nmap Scripting Engine (NSE), and at the end, it returns the final results of the scan. It is divided into three main functions;
Vulscan: Vulscan is a module that extends Nmap's ability to scan for network vulnerabilities. This is an NSE script that assists in the discovery of vulnerabilities on a single target or a network. This script focuses on service and version detection in order to determine the severity of vulnerabilities on the target computer or network. The module uses the most famous databases of vulnerability which includes all the officially announced security issues. The pre-installed databases are

scipvuldb.csv - https://vuldb.com
cve.csv - https://cve.mitre.org
securityfocus.csv - www.securityfocus.com/bid
xforce.csv - https://exchange.xforce.ibmcloud.com/
expliotdb.csv - https://www.exploit-db.com
openvas.csv - http://www.openvas.org
securitytracker.csv - https://www.securitytracker.com
osvdb.csv - http://www.osvdb.org
Vulners: Vulners is another NSE script that makes use of publicly available services to
offer pertinent information about vulnerabilities with more than more than 250 GB
database size. It is integrated with the nmap libraries in order to improve Nmap's ability
to scan for network vulnerabilities.
Comprehensive: Comprehensive mode makes use of both modules together to detect the
highest number possible of vulnerabilities. It checks the results of their return in
accordance with their priority in order without any repetitions.

In an aspect present invention relates to an API-based automated network scanner method comprising an optimized host discovery and open port scanner and service-version enumerator and vulnerability assessment application using the Network Mapper (Nmap) and Scripting Engine (NSE) integrated with enhanced VulScan and Vulners modules and their databases with enhancement and optimization rules to find Common Vulnerabilities and Exposures (CVE) and possible security issues and threats to provide a detailed report about the results, wherein said method comprises the steps of;
a) Dealing with input request
b) Carrying out the host discovery
c) Carrying out port scanning
d) Enumeration of service and version
e) Detecting Operating System
f) Detecting common vulnerabilities and exposures (CVE) and the possible threats via the Nmap Scripting Engine (NSE),
g) Providing a detailed report in an acceptable format such as JSON, XML or TXT

In an aspect of the invention host discovery (b) is carried out with one of the methods selected from (i) the group comprising ARP detection, (ii) Using a list scan rather than a PING scan by setting the target host's state to “HOST UP” and (iii) sending four different types of data packets to determine whether the target host is online.

### Examples

Various scenarios based on real-world events have been used to evaluate the scheme's performance. We have tested the project in 20 distinct environments, which include most of the possible structures. The test cases are;

Metasploitable-2: is a deliberately vulnerable Linux virtual server meant for target practice, training, and exploit testing. Metasploitable2, unlike other vulnerable virtual machines, focuses on operating system and network services layer vulnerabilities rather than custom, vulnerable programs. In terms of vulnerabilities that might be uncovered in a production setting, it has a very similar scenario.

Bee-box-v1.6: bee-box is a modified Linux Virtual Machine that comes with a buggy web application pre-installed (bWAPP). It gives the chance to investigate almost all vulnerabilities in web applications. bWAPP is a purposefully unsafe web application that is free and open source. It assists web security enthusiasts, developers, and students in identifying and preventing web vulnerabilities. It can also be beneficial to prepare for effective penetration testing and ethical hacking tasks. The fact that bWAPP has over 100 online vulnerabilities is what sets it apart. It covers all significant known web flaws, as well as all OWASP Top 10 project vulnerabilities. bWAPP is a MySQL database-driven PHP application.

Metasploitable-1: The Metasploit project is a computer security project helping with penetration testing and IDS signature development by providing knowledge about security flaws. This is the initial version of metasploitable, which is based on an Ubuntu 8.04 server that has been customized. Tomcat 5.5 (with weak credentials), distcc, tikiwiki, twiki, and an earlier mysql are among the insecure programs provided. As previously stated, it is a purposely vulnerable virtual system intended for target practice, training, and exploit testing. It focuses on operating system and network services layer vulnerabilities.

BTRsys1 and BTRSys2.1: BTRsys project contains intermediate-level boot-to-root susceptible images, with the primary goal of gaining shell access by attacking vulnerable services on the machine, which is a distinct scenario from the real-world probable risks.

g0rmint: This buggy machine is totally based on a real-world scenario that has been encountered while performing testing for a client's website. It is one of the advanced scenarios in obtaining a limited shell.

Hades-v1.0.1: Hades is yet another boot2root challenge designed mainly for experienced researchers. Reverse engineering, sploit creation, and a thorough understanding of computer architecture will all be required to exploit this machine successfully. The goal of it is to gradually get more access to the box until the root account is reached.

vulnVoIP: VulnVoIP is built on the AsteriskNOW distribution, which has some flaws in it. The goal is to track down VoIP users, crack their passwords, and acquire access to the support account voicemail message system. To add a little spice to the mix, this specific distribution is also vulnerable to a well-known exploit that makes it simple to obtain access to the system's root shell. It is one of the few real-life VoIP test environments available.

VPLE: The Vulnerable Pentesting Lab Environment (VPLE) is a Linux virtual system that is designed to be purposefully vulnerable. This virtual machine can be used for education, tool testing, and standard penetration testing labs. VPLE includes Web-dvwa, Mutillidae, Webgoat, Bwapp, Juice-shop, Security-ninjas, and a Wordpress environment.

Tr0ll2: The Tr0ll machine has been designed to look and act similarly to the Offensive Security Certified Professional (OSCP) system, and it is prepared to troll the penetration tester at some points. Tr0ll2 is a level of difficulty that is higher than the previous level, Tr0ll1. This is a scenario of intermediate difficulty.

sick0s1.1: This server provides a clear example of how hacking tactics can be used to infiltrate a network in a secure setting. This virtual computer is comparable to the ones used in the Offensive Security Certified Professional labs (OSCP). The goal is to get into the network/machine and gain administrative/root access to it.

MorningCatch: Morning Catch is a VMware virtual machine that demonstrates targeted client-side attacks and post-exploitation, akin to Metasploitable. A website for a bogus seafood firm, a self-contained email infrastructure, and vulnerable Linux and Windows client-side desktop environments can all be found on this virtual server. It also uses WINE to run a few weak Windows apps.

NETinVM UML 2016: NETinVM is a VMware virtual machine image that exposes a full computer network to the user. As a result, NETinVM can be used to learn about operating systems, computer networks, and security for systems and networks. Furthermore, NETinVM is a VMware virtual machine image that provides a set of User-mode Linux (UML) virtual machines that are ready to use. When the UML virtual machines are started, they build a whole computer network. The Linux operating system is used by all of the virtual computers. It is a full system that displays a real-world network.

hackxor1: is a webapp testing environment where vulnerabilities must be located and exploited to progress through the system. similar to WebGoat, however, with a focus on realism and challenge. XSS, CSRF, SQLi, ReDOS, DOR, command injection, and other exploits are included. Client attack simulation using HtmlUnit, and realistic vulnerabilities modeled by Google, Mozilla, and other platforms are just a few of the features available

Brainpan2, CySCA2014InABox, DonkeyDocker-v1.0, GoatseLinux-1.0-VM, UltimateLAMP-0.2 and w1r3s.v1.0.1: These machines are also designed to have different schemes from real-life ones to practice and test the new penetration testing tools being developed. These vulnerable servers are based on real-world scenarios and similar to OSCP labs.

In each of these test cases, we have tested the automation of active reconnaissance in this project, starting with host discovery, port scanning, service-version enumeration, and finalizing with the vulnerability detection option #1/#2/#3. Option one enumerates the services working on the opened ports, the versions of each service, and then detects the vulnerabilities based on the “VulScan” script. Option two goes over the same process depending on the “Vulners” script. In the last one (option3), it checks the system with the help of both of the scripts together. In table I, we can see the time elapsed in minutes for each step of the process for each test case. And the second table (Table II) shows the total time elapsed in minutes for the whole process with the used vulnerability detection option for each test case.

TABLE 1
RESULTS OF TEST CASES

| | Time Elapsed in Minutes | | | | | Results | | | | |
|---|---|---|---|---|---|---|---|---|---|---|
| Virtual | | | S.V. | S.V. | S.V. | Total | S.V. | S.V. | S.V. | OS |
| Machine | Host | Port | Enum. | Enum. | Enum. | Open | Enum. | Enum. | Enum. | Detection |
| Name | Discovery | Scan | Option#1 | Option#2 | Option#3 | Ports | Option#1* | Option#2* | Option#3* | Accuracy |
| Metasploitable2 | 0.025 | 0.316 | 5.020 | 2.718 | 5.051 | 30 | 41692 | 417 | 42109 | 100 |
| Bee-box_v1.6 | 0.025 | 0.325 | 3.835 | 2.444 | 3.877 | 19 | 3405 | 544 | 3949 | 100 |
| Brainpan2 | 0.025 | 0.287 | 3.183 | 3.192 | 3.191 | 2 | 6 | 9 | 15 | 100 |
| Metasploitable1 | 0.025 | 0.403 | 4.127 | 2.720 | 4.143 | 13 | 19794 | 403 | 20197 | 100 |
| BTRsys1 | 0.023 | 0.357 | 0.487 | 0.358 | 0.526 | 3 | 594 | 130 | 724 | 100 |
| BTRSys2.1 | 0.115 | 0.407 | 0.596 | 0.281 | 0.625 | 3 | 606 | 199 | 805 | 100 |
| CySCA2014InABox | 0.117 | 0.490 | 3.98 | 2.882 | 4.194 | 17 | 52011 | 395 | 52406 | 100 |
| DonkeyDocker_v1.0 | 0.026 | 0.336 | 0.397 | 0.183 | 0.391 | 2 | 500 | 150 | 650 | 100 |
| g0rmint | 0.025 | 0.302 | 0.385 | 0.192 | 0.414 | 2 | 542 | 199 | 741 | 100 |
| Hades_v1.0.1 | 0.023 | 0.481 | 1.872 | 0.079 | 0.180 | 2 | 370 | 27 | 397 | 100 |
| GoatseLinux_1.0 | 0.025 | 0.359 | 3.977 | 3.309 | 3.994 | 9 | 5325 | 228 | 5553 | 100 |
| vulnVolP | 0.024 | 0.398 | 3.239 | 2.708 | 3.244 | 8 | 4329 | 110 | 4439 | 100 |
| VPLE | 0.029 | 0.347 | 1.212 | 0.291 | 1.081 | 8 | 1249 | 245 | 1494 | 100 |
| Tr0112 | 0.026 | 0.384 | 0.559 | 0.259 | 0.599 | 3 | 373 | 23 | 396 | 100 |
| sick0s1.1 | 0.039 | 1.885 | 0.489 | 0.292 | 0.531 | 3 | 399 | 33 | 432 | 100 |
| MorningCatch | 0.121 | 0.593 | 0.867 | 0.235 | 0.883 | 6 | 1524 | 34 | 1558 | 100 |
| NETinVM 2016 | 0.081 | 0.304 | 0.306 | 0.179 | 0.267 | 2 | 0 | 0 | 0 | 100 |
| hackxor1 | 0.038 | 2.714 | 0.311 | 0.183 | 0.386 | 1 | 587 | 0 | 587 | 100 |
| UltimateLAMP-0.2 | 0.037 | 0.370 | 0.276 | 0.287 | 0.304 | 1 | 35 | 31 | 66 | 100 |
| w1r3s.v1.0.1 | 0.130 | 1.065 | 0.991 | 0.406 | 0.890 | 4 | 3450 | 62 | 3512 | 100 |
| MIN | 0.023 | 0.287 | 0.276 | 0.079 | 0.180 | 1 | 0 | 0 | 0 | 100 |
| AVG | 0.049 | 0.606 | 1.806 | 1.160 | 1.738 | 7 | 6840 | 162 | 7002 | 100 |
| MAX | 0.130 | 2.714 | 5.020 | 3.309 | 5.051 | 30 | 52011 | 544 | 52406 | 100 |

TABLE II
TOTAL ELAPSED TIME IN MINUTES

| | Total Time | Total Time | Total Time |
|---|---|---|---|
| Virtual Machine Name | Option#1 | Option#2 | Option#3 |
| Metasploitable2 | 5.362 | 3.060 | 5.393 |
| Bee-box_v1.6 | 4.185 | 2.794 | 4.227 |
| Brainpan2 | 3.495 | 3.504 | 3.503 |
| Metasploitable1 | 4.554 | 3.147 | 4.570 |
| BTRsys1 | 0.868 | 0.738 | 0.906 |
| BTRSys2.1 | 1.117 | 0.802 | 1.146 |
| CySCA2014InABox | 4.592 | 3.489 | 4.801 |
| DonkeyDocker_v1.0 | 0.759 | 0.545 | 0.753 |
| g0rmint | 0.712 | 0.518 | 0.740 |
| Hades_v1.0.1 | 2.377 | 0.583 | 0.685 |
| GoatseLinux_1.0_VM | 4.360 | 3.692 | 4.377 |
| vulnVoIP | 3.662 | 3.131 | 3.667 |
| VPLE | 1.588 | 0.666 | 1.457 |
| Tr0ll2 | 0.969 | 0.669 | 1.010 |
| sick0s1.1 | 2.414 | 2.216 | 2.455 |
| MorningCatch | 1.581 | 0.948 | 1.597 |
| NETinVM UML 2016 | 0.691 | 0.564 | 0.652 |
| hackxor1 | 3.063 | 2.935 | 3.138 |
| UltimateLAMP-0.2 | 0.683 | 0.694 | 0.711 |
| w1r3s.v1.0.1 | 2.186 | 1.601 | 2.084 |
| MIN | 0.683 | 0.518 | 0.652 |
| AVG | 2.461 | 1.815 | 2.394 |
| MAX | 5.362 | 3.692 | 5.393 |

The evaluation process over numerous test environments outlined in the preceding section demonstrates the project's stability and high performance. Users can check the status of the host (up/down), examine the open ports, find the exposed service and version information, and finally investigate all possible risks, threats, and vulnerabilities in an automated manner using three different detection functions provided as quick, detailed, and comprehensive. The minimum, average, and maximum values of the time elapsed for each endpoint test case are shown in FIG. 6.

In our approach, the quick version relies on the Nmap Scripting Engine's Vulners module, which provides the common vulnerabilities and exposures reference numbers related to the enumerated service and version information, as well as the exploit priority. The detailed option is based on the VulScan script, which gives a significantly longer list that includes not only the CVE reference number but also additional potential risks classified by various types of reference numbers. As we mentioned in the methods section, this module is integrated with the world's most well-known eight vulnerability databases, which cover nearly every possible risk related to the organization's technology. The final comprehensive method combines both scripts and returns the unique findings. FIG. 7 shows the high performance of each strategy.

The relationship between the total open port number and the total elapsed time for the enumeration and detection operation is shown in FIG. 8. As it can be expected, the time increases as the total number of open ports grows. However, the increment in time is only about 12 seconds for each port regardless of the number of vulnerabilities. Castiglione et al. [36] indicated that performing a manual approach would take one minute per vulnerability. For example, our system was able to detect 42109 vulnerabilities only in five minutes for Metasploitable2 environment. The best case in the increment ratio was 6 seconds and the worst case was 1.5 minute in the test cases. This emphasises the stability and proves the efficiency of the suggested schema in terms of its high processing speed

Last but not least, the suggested technique will play an important role in system security by allowing companies and system administrators to scan their systems on a frequent and regular basis with the minimal resources they have. Furthermore, this allows for rapid updates to newly discovered software vulnerabilities. Our scanner is used to demonstrate how simple it is to scan a complicated enterprise-grade web application. Attempting to enumerate the service-version and vulnerability information from all ports without making any optimization rule to enhance the performance of the operation is the most common mistake made by other researchers.

As mentioned above, the aim of this invention is to provide a generic and optimized approach for automating the process using the available and dynamic vulnerability and exposure datasets. We've made it apparent that our technique is primarily focused on automating the port scanning and vulnerability assessment phases of reconnaissance, which are handled by Nmap's algorithms, Nmap Scripting Engines (NSEs) and Vulscan and Vulners modules.

All in all, we offer a useful schema for the active information-gathering phase, which penetration testers and system administrators can use during penetration testing. The project includes an automated API-based IP and port scanner, a service-version enumerator, and a vulnerability detection system. In this system, the Network Mapper (Nmap) is used to collect information with high accuracy using the criteria in our schema. Furthermore, the work has been implemented as a RESTful-API server with the purpose of easy integration for real-world scenarios, allowing administrators to scan and secure their networks more quickly while also being entirely scalable and flexible to their demands and growth.

Furthermore, the results of the test cases were satisfying and beyond our expectations. We almost covered all the possible basic environments based on real-life scenarios. The outcomes were very different in comparison to a more manual technique. We were able to gather port and vulnerability information in a very short time with high accuracy.

1. An API-based automated network scanner method comprising an optimized host discovery and open port scanner and service-version enumerator and vulnerability assessment application using a Network Mapper (Nmap) and Scripting Engine (NSE) integrated with enhanced VulScan and Vulners modules and their databases with enhancement and optimization rules to find Common Vulnerabilities and Exposures (CVE) and possible security issues and threats to provide a detailed report about the results.

2. A method according to claim 1, wherein said method comprises the steps of:
a) dealing with an input request;
b) carrying out host discovery;
c) carrying out port scanning;
d) enumeration of service and version;
e) detecting an Operating System;
f) detecting common vulnerabilities and exposures (CVE) and the possible threats via the Nmap Scripting Engine (NSE); and
g) providing a detailed report in an acceptable format such as JSON, XML or TXT.

3. A method according to claim 2, wherein host discovery (b) is carried out with one of the methods selected from the group comprising (i) ARP detection, (ii) using a list scan rather than a PING scan by setting the target host's state to “HOST UP” and (iii) sending four different types of data packets to determine whether the target host is online.

4. A method according to claim 3, wherein the four different types of data packets are ICMP Echo request, TCP Syn request, TCP Ack Request, ICMP Timestamp request.

5. A method according to claim 2, wherein operating system detection (e) comprises; (i) Nmap running a sequence generation test, sending six TCP probing packets, and extracting the data fingerprint SEQ/OPS/WIN/T1, (ii) Nmap selects a closed UDP port, a closed TCP port, and an open TCP port for complete TCP/UDP/ICMP detection and fingerprint data extraction, respectively and finally, (iii) Nmap compares the fingerprint attributes of known systems included with Nmap to the findings of the detection.

6. A method according to claim 2, wherein vulnerability detection (f) comprises the use of NSE scripts Vulscan or vulners or a comprehensive mode that makes use of both Vulscan and Vulners scripts.
